(19) United States
(12) Patent Application Publication
(10) Pub. No.: US 2023/0126132 A1
(43) Pub. Date: Apr. 27, 2023

(54) SIDE REAR-VIEW MIRROR CONTROL APPARATUS AND METHOD FOR VEHICLE

(71) Applicant: HYUNDAI MOBIS CO., LTD., Seoul (KR)

(72) Inventor: Jae Young LEE, Yongin-si (KR)

(73) Assignee: HYUNDAI MOBIS CO., LTD., Seoul (KR)

(21) Appl. No.: 17/817,326

(22) Filed: Aug. 3, 2022

(30) Foreign Application Priority Data
Oct. 26, 2021 (KR) 10-2021-0143439

(51) Int. Cl. B60R 1/08; B60R 1/07

(52) U.S. Cl. CPC B60R 1/081; B60R 1/07; B60R 2001/1253

(57) ABSTRACT

An apparatus and method for controlling side-view mirrors, adjusting the side-view mirrors on the basis of a lane while a driving direction is changed, and provide a driver with changed viewing angles. Thereby, there are effects capable of securing a field of view of a driver for a lane for movement, improving a blind spot, providing the same viewing angle of the side-view mirrors as a straight driving situation, and an effect of enabling other vehicles with ease to prevent occurrence of an accident and to improve safety of the vehicle.

### CROSS-REFERENCE TO RELATED APPLICATION

This application claims priority from and the benefit of Korean Patent Application No. 10-2021-0143439, filed on Oct. 26, 2021, which is hereby incorporated by reference for all purposes as if set forth herein.

### BACKGROUND

### Field

Exemplary embodiments of the present disclosure relate to an apparatus and method for controlling side-view mirrors of a vehicle, which control the side-view mirrors on the basis of a lane during driving and which avoid formation of blind spots of a driver.

### DISCUSSION OF THE BACKGROUND

Vehicles are commonly equipped with a rearview mirror in the upper middle of the interior thereof so as to allow a driver to check the rear thereof, and side-view mirrors on the left and right external sides thereof.

Such side-view mirrors are representative devices that allow a driver to view a side-rear region, that are mounted on the sides of the vehicle, and that reflect light from the rear sides of the vehicle to the driver.

Accordingly, the driver can check the rear of the vehicle through a rearview mirror, check the rear of the vehicle, especially rear to the left or right, through the side-view mirrors provided on the left and right sides, and change lanes while checking if other vehicles are approaching from the rear to the left or right.

In the side-view mirrors, a viewing angle becomes wider in proportion to a size of the mirror, but aerodynamic performance or wind noise level of the vehicle may be lowered, so that the side-view mirror may be limited in size. Due to the size limitation of the side-view mirrors, a convex mirror may be used to allow a driver to check a wider region, despite the having the same size as a conventional mirror.

However, such a convex mirror can only display a wider range by increasing a curvature thereof. This causes an increase in distortion of an image, and thus there may be a problem in that it may be difficult to discriminate objects within the image, even though the driver can see to the rear through the convex mirror. Due to the distortion of the image of the convex mirror, it may be difficult for a driver to recognize a relative distance to another vehicle and how close an object located behind the driver's vehicle, i.e. the other vehicle, is located in reality. Thus, there is a limitation in increasing the viewing angle.

Due to the restriction of the size and curvature of the side-view mirror, a blind spot may occur in a given range. When another vehicle is located in the blind spot, a driver may fail to recognize the other vehicle, even if the other vehicle is actually located at a close distance behind, and attention needs to be paid.

Further, when a vehicle changes lanes during driving, a steering wheel is controlled, and thus a driving direction of the vehicle is changed. In this case, the viewing angle of the side-view mirror is also changed while the driving direction is changed. Thus, another vehicle, checked before changing the driving direction, may be located within the blind spot, and thus there is a problem that a driver cannot check the situation.

When the other vehicle is accelerated, in a situation in which the other vehicle cannot be checked, the driver cannot see the other vehicle, which may lead to an accident such as a collision of the vehicle.

To remove the blind spot problem of the side-view mirrors, side-view mirrors are configured to be controlled in Korean Patent Application Publication No. 10-2019-0135883. The prior-art disclosure is configured to sense left and right rotation angles of a tire to regulate the side-view mirrors according to an angle of inclination between the tires with respect to driver-side side-view mirrors that are installed on the sides of the driver and can allow the river to observe the rear side of the vehicle.

However, this method cannot discriminate a change of lanes from a rotary type road feature, and there may be a problem in that a viewing angle is limited to a lower side, so that this method is a problem in that it is difficult to be applied in a situation in which the lane is changed.

Accordingly, there is a need for a method of adjusting the side-view mirrors of the vehicle so as to be suitable for a situation in which the vehicle changes lanes during linear driving or where the vehicle travels through a rotary type road feature, thereby reducing the blind spot to enlarge the viewing angle.

### PRIOR ART DOCUMENT

### Patent Document

Korean Patent Application Publication No. 10-2019-0135883

### SUMMARY

Various embodiments are directed to providing an apparatus and method for controlling side-view mirrors, adjusting side-view mirrors to secure a viewing angle and remove a blind spot while changing or rotating around lanes.

Various embodiments are directed to an apparatus and method for controlling side-view mirrors, which discriminate a lane change and a rotary type road feature on the basis of a lane, using an image, adjust the side-view mirrors on the basis of the lane and a driving direction, and provide a changed viewing angle.

To achieve the above objectives, an apparatus for controlling side-view mirrors according to the present disclosure includes: side-view mirrors including a first mirror and a second mirror and configured to provide a field of view to a rear side of a vehicle; a driving module configured to adjust positions of the side-view mirrors; a camera including at least one camera and configured to record images; a turn signal switch configured to input a signal for indicating a vehicle moving direction; and a processor configured to determine the vehicle moving direction in response to the signal of the turn signal switch to recognize lanes from the images, to calculate a viewing angle between the lane and a driving direction, and to control the driving module such that the positions of the side-view mirrors according to the included angle.

The processor may determine that the vehicle will move to the left side when a signal is received from a left switch of the turn signal switch to thereby recognize a left lane of a driving lane, and may determine that the vehicle will move to the right side when a signal is received from a right switch to thereby recognize a right lane of the driving lane.

The apparatus for controlling side-view mirrors may further include a sensor configured to sense a speed of the vehicle, wherein the processor controls a speed for changing the positions of the side-view mirrors in response to the speed of the vehicle which is received from the sensor.

The processor may recognize the lane and a road sign from the images, output an announcement to conduct low speed driving in a speed limit zone according to the road sign, and control the positions of the side-view mirrors to be rapidly changed during low speed driving.

The processor may perform setting so as to divide into low speed driving, common driving, and high speed driving according to the vehicle speed, to adjust the positions of the side-view mirrors at a first speed during common driving, to adjust the positions of the side-view mirrors at a second speed, faster than the first speed, during low speed driving, and to adjust the positions of the side-view mirrors at a third speed, slower than the first speed, during high speed driving.

In an embodiment, when it is determined that entry into the lane or movement to the lane is completed, the processor may apply a return command to the driving module so as to return the positions of the side-view mirrors to a reference position.

In an embodiment, when the lane and the driving direction coincide to each other, and when the turn signal switch is switched off, the processor may determine that the movement to the lane is completed.

The driving module may be configured to: return the positions of the side-view mirrors to a preset reference position when the return command is input; and return the positions of the side-view mirrors to a position before the movement to the lane when the reference position is not set.

The driving module may calculate a rotation angle for the side-view mirrors which corresponds to the included angle, may drive a motor connected to the side-view mirrors, and may adjust the positions of the side-view mirrors to at least one of up, down, left, and right.

To achieve the above objectives, a method of controlling a side-view mirror control apparatus includes: allowing a signal for indicating a moving direction with a turn signal switch during driving; recording images with a camera including at least one camera; determining the vehicle moving direction in response to the signal of the turn signal switch, and recognizing a lane from the image in correspondence to the vehicle moving direction; calculating an included angle between the lane and the driving direction; and adjusting positions of the side-view mirrors with respect to any one of the side-view mirrors including a first mirror and a second mirror.

The recognizing of the lane may include determining that the vehicle will move to a left side when a signal is received from a left switch of the turn signal switch, recognizing a left lane of the driving lane from the image, determining that the vehicle will move to a right side when a signal is received from the right switch, and recognizing a right lane of the driving lane from the image.

The calculating of the included angle may further include: calculating an equation of the lane connecting points or lines extracted from the recognized lanes; and calculating the included angle on the basis of the equation of the lane.

The method of controlling a side-view mirror control apparatus may further include: before adjusting the positions of the side-view mirrors, sensing a speed of the vehicle; and setting a speed for changing the positions of the side-view mirrors in correspondence to the speed of the vehicle.

The setting of the speed may include: dividing driving into low speed driving, common driving, and high speed driving according to the speed of the vehicle; and setting the vehicle so as to adjust the positions of the side-view mirrors at a first speed during common driving, adjust the positions of the side-view mirrors at a second speed, faster than the first speed, during low speed driving, and adjust the positions of the side-view mirrors at a third speed, slower than the first speed, during high speed driving.

The adjusting of the positions of the side-view mirrors may further include: calculating rotation angles of the side-view mirrors which correspond to the included angles; and driving motors connected to the side-view mirrors to adjust the positions of the side-view mirrors to a direction of at least one of up, down, left, and right.

The method of controlling a side-view mirror control apparatus may further include: determining that the movement to the lane is completed in a case of any one of a case in which the lane and the driving direction coincide with each other and a case in which the turn signal switch is switched off; and returning the positions of the side-view mirrors when the movement to the lane is completed.

The returning of the positions of the side-view mirrors may include: returning the positions of the side-view mirrors to preset reference positions; and returning the positions of the side-view mirrors to positions before moving to the lane when the reference position is not set.

According to an aspect, the apparatus and method for controlling side-view mirrors of the present disclosure adjusts the side-view mirrors to change viewing angles of the side-view mirrors when changing a lane, thereby there are effects of securing a field of view of a driver for an entering lane, and improving blind spots.

The present disclosure can adjust side-view mirrors on the basis of a lane to provide viewing angles of the side-view mirrors which are equal to a straight driving situation.

According to an aspect, the present disclosure adjusts the side-view mirrors to change the viewing angle, and thereby there are effects of preventing accidents such as a collision occurring due to a failure to recognize other vehicles, preventing a collision with an obstacle located on a road or adjacent to the road, thus improving safety of the vehicle.

### BRIEF DESCRIPTION OF THE DRAWINGS

FIG. 1 is a block diagram in which a configuration of an apparatus for controlling side-view mirrors according to an embodiment of the present disclosure is briefly illustrated.

FIGS. 2A and 2B are views referred to describe changes in viewing angles of side-view mirrors when a lane is changed according to an embodiment of the present disclosure.

FIG. 3 is a view referred to describe position adjustment of the side-view mirrors of the apparatus for controlling side-view mirrors according to an embodiment of the present disclosure.

FIG. 4 is a flow chart in which a method of controlling the apparatus for controlling side-view mirrors according to an embodiment of the present disclosure.

FIG. 5 is a flow chart in which a control method according to a speed of the apparatus for controlling side-view mirrors according to an embodiment of the present disclosure.

DETAILED DESCRIPTION OF THE ILLUSTRATED EMBODIMENTS

As is traditional in the corresponding field, some exemplary embodiments may be illustrated in the drawings in terms of functional blocks, units, and/or modules. Those of ordinary skill in the art will appreciate that these block, units, and/or modules are physically implemented by electronic (or optical) circuits such as logic circuits, discrete components, processors, hard-wired circuits, memory elements, wiring connections, and the like. When the blocks, units, and/or modules are implemented by processors or similar hardware, they may be programmed and controlled using software (e.g., code) to perform various functions discussed herein. Alternatively, each block, unit, and/or module may be implemented by dedicated hardware or as a combination of dedicated hardware to perform some functions and a processor (e.g., one or more programmed processors and associated circuitry) to perform other functions. Each block, unit, and/or module of some exemplary embodiments may be physically separated into two or more interacting and discrete blocks, units, and/or modules without departing from the scope of the inventive concept. Further, blocks, units, and/or module of some exemplary embodiments may be physically combined into more complex blocks, units, and/or modules without departing from the scope of the inventive concept.

Hereinafter, the present disclosure will be described below with reference to the accompanying drawings.

In this process, thicknesses of lines shown in the drawings and sizes of constituent elements may be exaggerated for clarity and convenience. Further, the following terms are defined, considering their functions in the present disclosure, and may be varied according to intentions and customs of a user or a manager. Thus, the terms should be defined based on the contents of the entire specification.

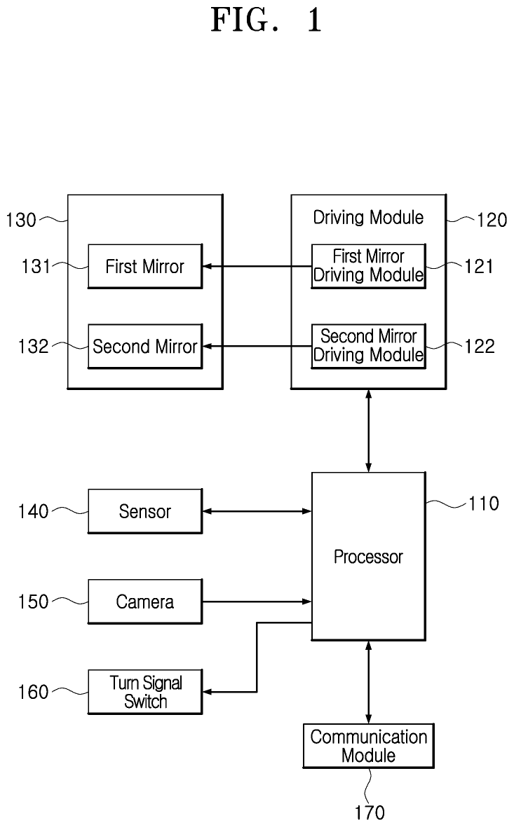

FIG. 1 is a block diagram in which a configuration of an apparatus for controlling side-view mirrors according to an embodiment of the present disclosure is briefly illustrated.

As illustrated in FIG. 1, an apparatus for controlling side-view mirrors includes a driving module 120, side-view mirrors 130, a sensor 140, a camera 150, a turn signal switch 160, a communication module 170, and a processor 110 for controlling overall operations.

The apparatus for controlling side-view mirrors is provided for a vehicle, and includes components of the vehicle.

The side-view mirrors 130 include a first mirror 131 installed on a left side or a driver seat side of the vehicle, and a second mirror 132 installed on a right side or a passenger seat side.

The side-view mirrors 130 are installed to face the rear side that is a direction opposite to a driving direction, and provides a driver with a viewing angle with respect to a rear to the left or right side of the vehicle. Each of the side-view mirrors 130 includes a convex mirror, and a mirror housing (not illustrated) that covers the convex mirror.

The driving module 120 includes a mirror driving module that is connected to the side-view mirrors 130 and adjusts the side-view mirrors 130.

The driving module 120 includes a first mirror driving module 121 connected to the first mirror 131, and a second mirror driving module 122 connected to the second mirror 132.

The first mirror driving module 121 and the second mirror driving module 122 are each installed in an interior of the mirror housing, and are connected to rear surfaces of the first mirror 131 and the second mirror 132, respectively.

The first mirror driving module 121 adjusts the first mirror 131 up, down, left and right. The second mirror driving module 122 adjusts the second mirror 132 up, down, left and right.

Each of the first mirror driving module 121 and the second mirror driving module 122 includes a connector connected to each of the mirrors, a motor generating power for adjusting the mirror, and a drive shaft allowing each of the mirrors to be moved or rotated up, down, left and right.

Further, each of the first mirror driving module 121 and the second mirror driving module 122 includes a moving means such as a rail or a rack and a rotating means, which are included in a drive shaft for upward, downward, leftward and rightward movement and rotation.

The turn signal switch 160 includes a left switch (not illustrated) and a right switch (not illustrated).

When the left switch is operated, the processor 110 controls a right turn signal lamp provided in the vehicle to be turned on and off. When the right switch is operated, the processor 110 controls a left turn signal lamp provided in the vehicle to be turned on and off.

The turn signal lamps are provided on the left and right sides of the vehicle in plural. The turn signal lamps are installed in a front portion, a front portion side, a rear portion, and a rear portion side of the vehicle. Further, according to the case, the turn signal lamp may be installed in an upper portion, a lower portion, or a side of the mirror housing of each of the side-view mirrors.

The communication module 170 includes a plurality of communication modules, and performs near field communications such as Bluetooth etc., wireless communications for connection with an external server etc., as well as CAN communication for data transmission and reception in the interior of the vehicle.

The communication module 170 communicates with a road information server that provides external database (DB) (not illustrated) or road information. The communication module 170 receives current position information of the vehicle, road information during travelling, traffic information, road stagnation information, information around a road, and weather information.

The communication module 170 can be connected with a portable terminal (not illustrated) of a driver through a near field communication module. In some cases, the communication module 170 may communicate with neighboring vehicles.

The sensor 140 senses information about driving states of the vehicle using a position sensor, a speed sensor, a temperature sensor, a pressure sensor, etc. of the vehicle, and sends the information to the processor 110.

Further, the sensor 140 detects whether or not an object around the vehicle exists using the plurality of sensors, and measures a distance from the detected object. For example, the sensor 140 senses an object adjacent to the surroundings of the vehicle using LiDAR, radar, an infrared sensor, an ultraviolet sensor, etc., for example other vehicles, and recognizes an environment around a driver's vehicle.

A data section (not illustrated) stores control data for controlling the vehicle, data sensed through the sensor 140, data transmitted and received through the communication module 170, and data for recorded images.

The data section stores data, in which information about the rotation angle of the side-view mirror corresponding to an included angle in order to adjust to the side-view mirror, in a table form. Further, data about speeds for adjusting positions of the side-view mirror according to the vehicle speed is stored in the data section.

Because each of the side-view mirrors 130 is a convex mirror used to widen the viewing angle, a relation between a necessary viewing angle and a rotation angle of the motor is a non-linear relation. Accordingly, the vehicle 1 can calculate motor rotation angles for necessary viewing angles of multiple steps on the basis of a person having an average physique according to a vehicle model, through a test, generate a look up table (LUT), and store the LUT in the data section. The LUT can be updated through a server accessed through the communication module 170.

The camera 150 includes at least one camera (not illustrated) that records images. The camera is installed adjacent to any one side of the front portion of the vehicle or a windshield of the vehicle, and records image in a front driving direction.

Further, the camera 150 may further include a rear camera installed in the rear of the vehicle and records rear images.

The camera 150 applies the recorded images to the processor 110, and the processor 110 analyzes the images to sense lanes, and recognizes a situation around the vehicle or the road. The camera 150 may further include an image processor of converting images according to a preset format.

The processor 110 changes a driving direction as the steering device provided in the vehicle is operated by a driver. The processor 110 can obtain information about a road on the basis of sensor data of the sensor 140 and images recorded by the camera 150, and can recognize objects around the vehicle.

The processor 110 extracts lanes on the basis of the images recorded from the camera.

The processor 110 is controlled such that the left or right turn signal lamp is turned on or off in response to operation of the turn signal switch 160.

When the turn signal switch 160 is operated, the processor 110 determines the operation to be a requirement of the driver for the lane movement, and predicts the driving direction.

The processor 110 determines that the vehicle will move in a direction in which the turn signal switch 160 is operated, i.e. moves to a left lane when the left switch is operated. The processor 110 determines that the vehicle will move across a right side dashed line when the right switch is operated.

The processor 110 predicts a driving direction toward the left or right side according to a direction of the turn signal switch, and extracts the lane from images of the camera 150.

The processor 110 calculates an included angle for adjusting the side-view mirrors 130 on the basis of the driving direction and the lane, and applies the included angle to the driving module 120. The driving module 120 calculates a rotation angle for adjusting actually a mirror in correspondence to the included angle, and controls the side-view mirrors 130.

The processor 110 calculates an equation of the lane extracted on the basis of the front of the vehicle, and calculates an included angle on the basis of the equation of the lane and applies the included angle to the driving module 120.

Since the lane is indicated by a linear or curved line, the processor can detect a point or a line from the lane recognized from the image, and calculate an equation by which a point and a line are connected. For example, in the case of a straight road, it is possible to calculate an equation for a linear equation and an equation for a curve in the rotary section.

The driving module 120 calculates a rotational angle so as to adjust the side-view mirrors 130.

The side-view mirrors 130 is controlled by calculating the rotation angle so as to adjust the side-view mirrors 130 on the basis of the data about the viewing angles of the side-view mirrors 130 in correspondence to the included angle.

For example, in the case where the left switch is operated, the processor 110, the driving direction of the vehicle is checked, and the equation for the extracted lane is calculated. The processor 110 calculates an angle between the lane and the driving lane of the vehicles, applies the angle between the driving directions, and applies the angle to the driving module 120 together with the control command.

Thus, the first mirror driving module 121 calculates the rotation angle between the side-view mirrors in correspondence to the included angle, and drives the motor to adjust the first mirror 131.

Further, when the right switch is operated, the processor 110 calculates an equation of the driving direction and the right lane, calculates an included angle on the basis of the calculated equation, and applies a control command including the included angle to the driving module 120. Accordingly, the second mirror driving module 122 calculates a rotation angle of the second mirror on the basis of the included angle, and adjusts the second mirror 132.

The processor 110 is designed to calculate the included angle during moving along the lane for the first mirror 131 or the second mirror 132, thereby enables a driver to secure a field of view. According to the case, the processor 110 can adjust both the first mirror 131 and the second mirror 132.

The processor 110 continuously calculates the included angle by comparison between the driving direction and the lane of the vehicle during moving along the lane, and thus can continuously adjust the side-view mirrors 130.

When the vehicle arrives at a driving direction and a lane or the parallel position, or when the included angle between the driving direction and the lane is less than a preset angle, the processor 110 determines that entry into the lane or movement to the lane is completed, and restores positions of the side-view mirrors 130.

Further, the processor 110 can apply a control command to the driving module 120 so as to restore the positions of the side-view mirrors when the turn signal switch 160 is turned off by a user.

In response to the control command of the processor 110 of the driving module 120, the side-view mirrors are adjusted to restore them to reference positions.

The reference position is a position set by a driver in a common driving state. The data section stores reference positions of the first mirror 131 and the second mirror 132.

When the reference position is not set, the driving module 120 restores positions of the side-view mirrors by setting a position before the movement of the lane as a reference position. Further, when the reference position is not set, the driving module 120 may restore a position of the mirror to an initial position set when the vehicle is released onto the market.

Further, the processor 110 can recognize road information such as a road sign from a road, and receive information about a vehicle speed from the sensor 140. The processor 110 can additionally adjust the side-view mirrors 130 on the basis of the road information and the vehicle speed.

The processor 110 can divide vehicle speeds received from the sensor 140 into low speed driving, common driving, and high speed driving according to the vehicle speed received from the sensor 140, and can differently set a speed at which a position of the side-view mirror 30 is adjusted according to the vehicle speed.

The processor 110 is set to adjust the positions of the side-view mirrors at a first speed during common driving, to adjust the positions of the side-view mirrors at a second speed, faster than the first speed, during low speed driving, and to adjust the positions of the side-view mirrors at a third speed, slower than the first speed, during high speed driving.

The second speed is faster than the first speed, and the third speed is slower than the first speed. During high speed driving, the driving direction is gradually changed without sharp change, and thus the positions of the side-view mirrors are adapted to be gradually changed in response to such a change.

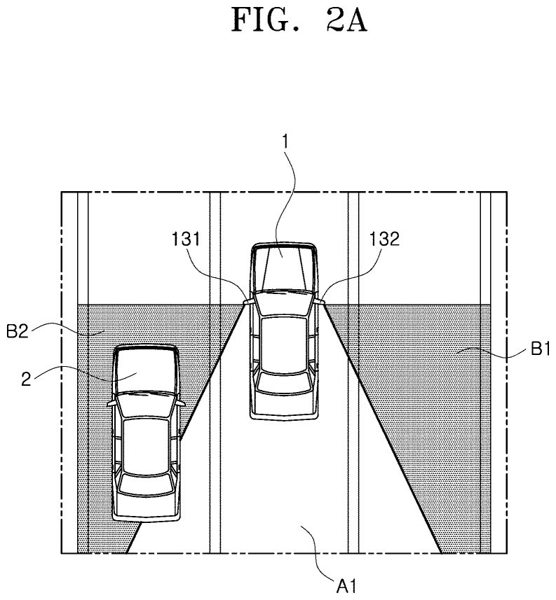

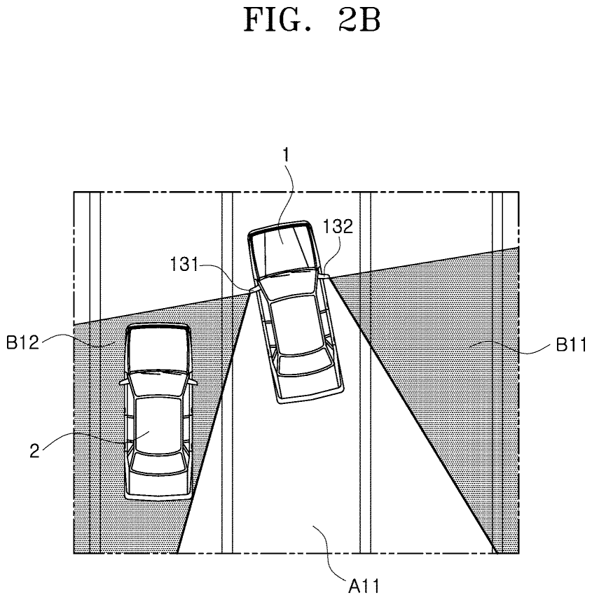

FIGS. 2A and 2B are views referred to describe changes in viewing angles of side-view mirrors when a lane is changed according to an embodiment of the present disclosure.

As illustrated in FIG. 2A, in a situation in which a first vehicle 1 is driven straight along a second lane, and in which a second vehicle 2 is driven straight along a first lane, the first vehicle 1 provides a driver with a viewing angle for a first region A1 through the side-view mirrors 130, the first mirror 131, and the second mirror 132.

The first vehicle 1 provides the viewing angle for the first region A1, and blind spots corresponding to second regions B1 and B2 are formed.

The driver of the first vehicle 1 can check a region corresponding to the first region A1 through the side-view mirrors 130, and thus can check a part of the second vehicle 2 through the first mirror 131 of the side-view mirrors.

As illustrated in FIG. 2B, the first vehicle 1 can move from a second lane to a first lane.

When a steering wheel of the first vehicle 1 is operated to enter the first lane, the viewing angle formed by the side-view mirrors 130 is changed while the driving direction is changed.

The driving direction of the first vehicle 1 is changed while the steering wheel is turned to the left side, and thus a viewing angle for a first-first region A11 from the side-view mirrors 130 is provided to a driver. At this time, blind spots for first-second regions B11 and B12 are formed.

As the steering wheel is operated in order for the first vehicle 1 to enter the first lane, a second vehicle 2 located in the first lane as illustrated is located at a blind spot B12. Therefore, the driver of the first vehicle 1 cannot check the second vehicle 2 through the side-view mirrors.

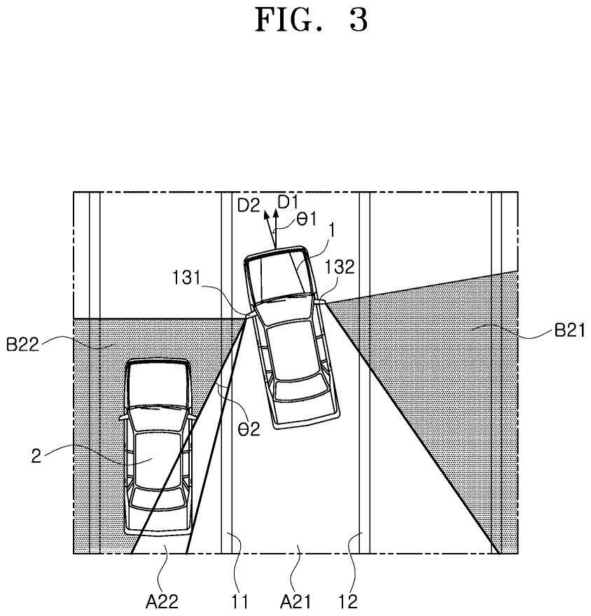

FIG. 3 is a view referred to describe position adjustment of the side-view mirrors of the apparatus for controlling side-view mirrors according to an embodiment of the present disclosure.

As illustrated in FIG. 3, a first direction D1 in which the driving direction of the first vehicle 1 is linearly driven by operation of the steering wheel is changed to the second direction D2. At this time, a driver operates a turn signal switch 160 to change the lane, and can turn on the turn signal lamp.

When a signal of the turn signal switch 160 is input, the processor 110 turns on the turn signal lamp for the left direction in response to the input signal.

As the signal of the turn signal switch 160 is input, the processor 110 determines the input signal to be an intention of the driver changing the lane, and extracts the lane from a front image input through the camera 150.

The processor 110 can extract a first lane 11 and a second lane 12 from the image. As the left switch is operated and the driving direction is changed to the second direction D2, the processor 110 computes an included angle θ1 on the basis of the first-first lane.

The processor 110 calculates a lane equation f(x) for the first lane 11. When the driving direction is the right side, the processor 110 calculates a lane equation for the second lane 12.

An angle between the first lane 11 and the driving direction, i.e., the second direction D2 extracted as the driving direction is changed from the first direction D1 to the second direction D2 is computed as an included angle θ1 by the processor 110.

The processor 110 can compute the included angle θ1 according to Equation 1 below using the lane equation f(x).

θ1=tan⁻¹(f(x)) Math Expression 1

Here, 61 is the included angle, x is the current position, and f(x) is the equation of the lane for the current position x.

When a direction of the turn signal switch 160 is different from the driving direction, the processor 110 computes the included angle θ1 on the basis of the driving direction. Further, the processor 110 can output warning against the difference between the direction of the turn signal switch and the driving direction through an output section (not illustrated).

The processor 110 applies a control command, which is used for adjusting the side-view mirrors 130 in correspondence to the included angle θ1, to the driving module 120. The processor 110 applies the calculated included angle θ1 to the driving module 120.

The processor 110 applies the control command to the driving module 120 so as to adjust a rotation angle of the first mirror 131 according to manipulation of the left switch and the change of the driving direction into the second direction D2.

The driving module applies the included angle θ1 to the first mirror driving module 121, and the first mirror driving module 121 calculates a rotation angle θ2 of the first mirror 131 which corresponds to the included angle θ1, and thereby adjusts the first mirror 131.

The first mirror driving module 121 drives a motor connected to the first mirror 131 to cause the first mirror 131 to move or rotate in proportion to the rotation angle θ2.

The first mirror driving module 121 calculates the rotation angle θ2 for adjusting the first mirror 131 in proportion to the included angle θ1 on the basis of the table stored in the data section, and controls the motor according to the calculation.

The first mirror driving module 121 calculates drive angle φ of the motor for moving the first mirror 131 in proportion to the rotation angle θ2 on the basis of the pre-stored table, and thus can control the motor.

Accordingly, the viewing angle of the first mirror 131 is enlarged from a 21 area A21 to 22 area A22. As the viewing angle is enlarged, the blind spot is reduced to 23 areas B21 and B22.

As the driver of the first vehicle 1 adjusts the first mirror 131 and thus the viewing angle is changed, the driver can check the second vehicle 2 located at the first lane through the first mirror 131.

The processor 110 continuously computes the included angle until the entry into the lane or the movement to the lane is completed, and applies the included angle to the driving module 120. The driving module 120 calculates the rotation angle corresponding to the included angle, thereby adjusting the side-view mirrors 130.

When the driving direction of the first vehicle is changed to be equal to the lane, when the included angle between the driving direction of the first vehicle and the lane is less than a preset angle, or when the turn signal lamp is switched off (turned off) by operation of the turn signal switch 160, the processor 110 determines that the entry into the lane or the movement to the lane is completed.

As the entry into the lane is completed, the processor 110 applies a return command to the driving module 120 such that the side-view mirrors 130 is returned to a reference position.

The driving module 120 adjusts a position of the side-view mirrors 130 to the preset reference position in response to the return command. When the reference position is not set, the driving module 120 can return to the position before changing the lane. In some cases, when the reference position is not set, the driving module 120 may return to an initial position that is set at a point of time when the vehicle has been released onto the market.

Meanwhile, when the road is a rotary type or a curve type, the processor 110 can adjust the side-view mirror in response to a change in the driving direction without moving the lane when the vehicle passes a rotary interval. Because the included angle calculated on the basis of the lane equation is consistently changed, when the included angle reaches a fixed value or above, the processor 110 can adjust the side-view mirror.

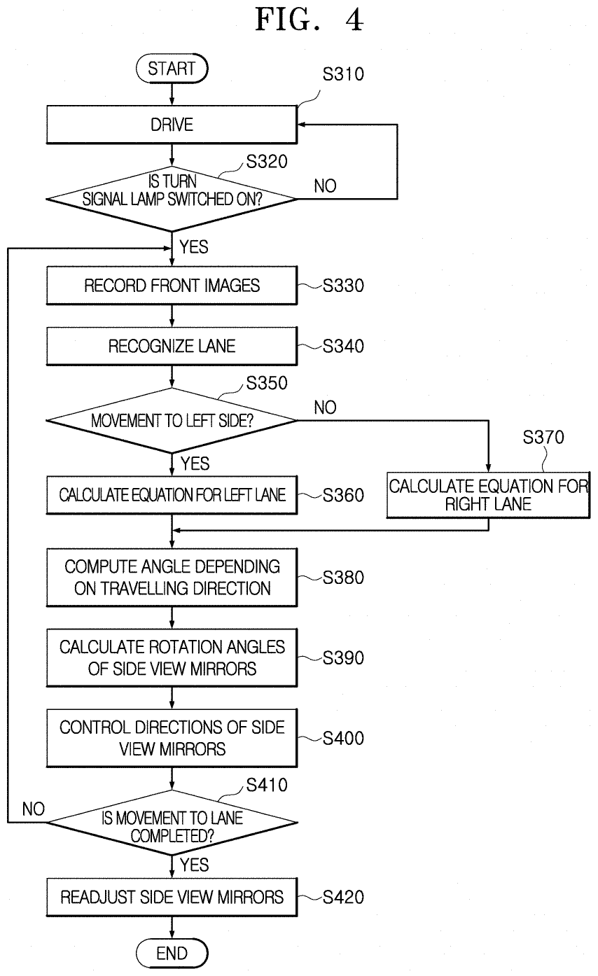

FIG. 4 is a flow chart in which a method of controlling the apparatus for controlling side-view mirrors according to an embodiment of the present disclosure.

As illustrated in FIG. 4, while the vehicle equipped with the apparatus for controlling side-view mirrors is driven (S310), when a signal of the turn signal switch 160 is input, the processor 110 turns ON a turn signal lamp (S320). When a signal of the left switch is input, the processor 110 turns on a left turn signal lamp. When a signal of the right switch is input, the processor 110 turns on a right turn signal lamp.

When the turn signal lamp is turned on by a signal of the turn signal switch 160, the processor 110 records a front image through the camera 150 (S330), and recognizes lanes from the images (S340). The processor 110 recognizes lanes of the left and right sides of the road along which the vehicle is driven.

When the driving direction of the vehicle is changed by the steering wheel, and when the driving direction is the left side (S350), the processor 110 calculates an equation of the left lane on the basis of the vehicle (S360).

Meanwhile, when the driving direction is the right side, the processor 110 calculates an equation of the right lane (S370).

When the driving direction is the left side in a state in which the left turn signal lamp is turned ON, the processor 110 determines this driving to be normal driving when the driving direction is the right side in the state in which the right turn signal lamp is turned on.

Meanwhile, when the direction of the turn signal lamp and the driving direction are different from each other, the processor 110 calculates the equation of the lane on the basis of the driving direction. When the direction of the turn signal lamp and the driving direction are different from each other, the processor 110 may output a warning message or a warning sound against the driving direction.

The processor 110 computes an angle between the driving direction and the lane of the vehicle to be the included angle on the basis of the equation for the lane (S380).

The processor 110 applies the control command including the included angle to the driving module 120.

The driving module 120 applies the included angle to the first mirror driving module or the second mirror driving module according to the driving direction. The mirror driving module calculates rotation angles for adjusting the positions of the mirrors (S390), and controls positions and directions of the side-view mirrors (S400).

For example, when the vehicle will move to the left lane, the first mirror driving module 121 calculates a rotation angle of the first mirror 131 depending on the included angle, drives the motor in correspondence to the rotation angle, and adjusts a position of the first mirror 131.

When the vehicle will move to the right lane, the second mirror driving module 122 calculates a rotation angle corresponding to the included angle, and drives a motor to adjust a position of the second mirror 132.

The processor 110 determines whether the movement to the lane is completed (S410). When the movement to the lane is completed, the processor 110 applies a return command to the driving module 120 so as to return the positions of the side-view mirrors.

When the driving direction of the first vehicle is changed to be equal to the lane, when the included angle between the driving direction and the lane is less than a preset angle, or when the turn signal lamp is switched off (OFF) by the operation of the turn signal switch 160, the processor 110 determines that the entry into the lane or the movement to the lane is completed.

The driving module readjusts and returns the positions of the side-view mirrors 130 in response to the return command to preset a reference position or a position before being adjusted to the movement to the lane (S420).

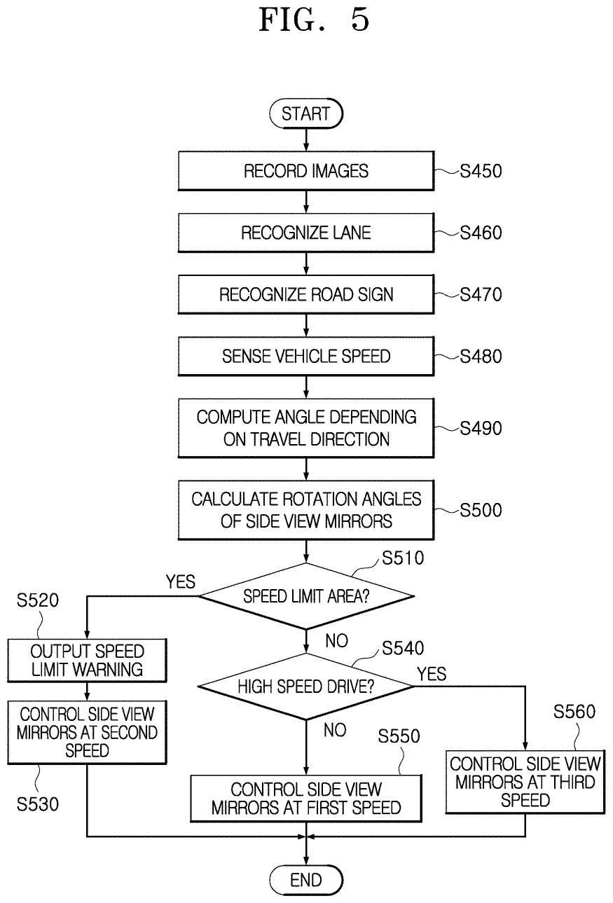

FIG. 5 is a flow chart in which a control method according to a speed of the apparatus for controlling side-view mirrors according to an embodiment of the present disclosure.

As illustrated in FIG. 5, the processor 110 records an image through the camera 150 (S450), and recognizes the lane from the image (S460).

Further, the processor 110 recognize a road sign from the image (S470), obtains road information, and receives vehicle speed information sensed from the sensor 140 (S480).

The processor 110 calculates the equation of the lane, and computes an angle between the lane and the driving direction as the included angle (S490), and controls the side-view mirrors 130 in response to the included angle, the road information, and the vehicle speed.

The processor 110 determines whether or not the road during driving is a speed limit zone (S510), and outputs a warning against a speed limit in the case of the speed limit zone (S520).

The processor 110 applies a control command, used for adjusting the side-view mirrors in response to the speed limit, to the driving module 120. In this case, the speed limit is based on the top speed limit. The processor 110 controls the side-view mirrors at a second speed such that the positions of the side-view mirrors are changed (S530).

The driving module 120 calculates the rotation angles of the side-view mirrors 130 in correspondence with the included angle, drives the motor at a second speed such that the positions of the side-view mirrors are changed in correspondence with the speed limit, and adjusts the positions of the side-view mirrors 130.

For example, when the vehicle travels in a school zone, the vehicle 1 recognizes a school zone sign or a speed limit sign, and thereby determines this zone to be the speed limit zone. While the vehicle 1 travels at a low speed, the vehicle 1 controls a speed, at which the positions of the side-view mirrors are changed in response to the speed of the vehicle, to the second speed (S530).

Meanwhile, the processor 110 determines whether or not the vehicle travels at high speed in correspondence to a current vehicle speed instead of the speed limit zone (S540). For example, when the vehicle speed is 80 km/h to 100 km/h or higher, the vehicle can be determined to be high speed driving, and a criterion for determining high speed driving can be changed according to setting.

When the vehicle is not determined to be high speed driving, the processor 110 allows the side-view mirrors 130 to be controlled at a first speed (S550).

The driving module 120 adjusts the side-view mirrors 130 to the rotation angle that is calculated in correspondence to the included angle, and allows the positions of the side-view mirrors 130 to be changed at the first speed.

Further, in the case of high speed driving, the processor 110 allows the side-view mirrors 130 to be controlled at a third speed (S560).

On the basis of the first speed, the second speed is set to be higher than the first speed, and the third speed is set to be lower than the first speed. During high speed driving, a moving distance per second of the vehicle 1 is longer than that during low speed driving, and the driving direction is gradually changed. For this reason, it is preferred that the positions of the side-view mirrors are changed to be slower than those during common driving.

Accordingly, the driving module 120 adjusts the side-view mirrors 130 to the rotation angle that is calculated in correspondence to the included angle, but drives the motor such that the positions of the side-view mirrors 130 are changed at the third speed, thereby adjusting the positions of the side-view mirrors 130.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. An apparatus for controlling side-view mirrors comprises a first mirror and a second mirror and configured to provide a field of view for a rear of a vehicle, said apparatus comprising:
a driving module configured to adjust positions of the side-view mirrors;
a camera comprising at least one camera and configured to record images;
a turn signal switch configured to input a signal for indicating a vehicle moving direction; and
a processor adapted to determine the vehicle moving direction in response to the signal of the turn signal switch to recognize a lane from the images, and to calculate an included angle between the lane and the driving direction to control the driving module such that the positions of the side-view mirrors are adjusted according to the included angle.

2. The apparatus for controlling side-view mirrors according to claim 1, wherein the processor is adapted to determine that the vehicle will move to a left side when a signal is received from a left switch of the turn signal switch, recognize a left lane of a driving lane, and determine that the vehicle will move to a right side when a signal is received from a right switch, and recognize a right lane of the driving lane.

3. The apparatus for controlling side-view mirrors according to claim 1, wherein the processor is adapted to recognize the lane from a front image among the images of the camera, calculate an equation of the lane connecting points or lines extracted from the lanes, and calculate the included angle based on the equation of the lane.

4. The apparatus for controlling side-view mirrors according to claim 1, further comprising a sensor configured to sense a speed of the vehicle,
wherein the processor is adapted to control a speed for changing the positions of the side-view mirrors in response to the speed of the vehicle received from the sensor.

5. The apparatus for controlling side-view mirrors according to claim 4, wherein the processor is adapted to recognize the lane and a road sign from the images, output an announcement to conduct low speed driving in a speed limit zone according to the road sign, and control the positions of the side-view mirrors to be rapidly changed during low speed driving.

6. The apparatus for controlling side-view mirrors according to claim 4, wherein the processor is adapted to:
divide into low speed driving, common driving, and high speed driving according to the vehicle speed,
adjust the positions of the side-view mirrors at a first speed during common driving,
adjust the positions of the side-view mirrors at a second speed, faster than the first speed, during low speed driving, and
adjust the positions of the side-view mirrors at a third speed, slower than the first speed, during high speed driving.

7. The apparatus for controlling side-view mirrors according to claim 1, wherein the processor is adapted to apply a return command to the driving module to return the positions of the side-view mirrors to a reference position when it is determined that entry into the lane or movement to the lane is completed.

8. The apparatus for controlling side-view mirrors according to claim 7, wherein the processor is adapted to determine that the movement to the lane is completed when the lane and the driving direction coincide with each other and the turn signal switch is switched off.

9. The apparatus for controlling side-view mirrors according to claim 7, wherein the driving module is configured to:
return the positions of the side-view mirrors to a preset reference position when the return command is input, and
return the positions of the side-view mirrors to a position before the movement to the lane when the reference position is not set.

10. The apparatus for controlling side-view mirrors according to claim 1, wherein the driving module is adapted to calculate a rotation angle for the side-view mirrors that corresponds to the included angle, drive a motor connected to the side-view mirrors, and adjust the positions of the side-view mirrors to at least one of up, down, left, and right.

11. The apparatus for controlling side-view mirrors according to claim 10, wherein:
the driving module includes a first mirror driving module and a second mirror driving module;
the first mirror driving module is adapted to adjust a position of the first mirror in correspondence to the rotation angle when there is movement to a left side; and
the second mirror driving module is adapted to adjust the position of the first mirror in correspondence to the rotation angle when there is movement to a right side.

12. A method of controlling a side-view mirror control apparatus, the method comprises:
allowing a signal for indicating a moving direction with a turn signal switch during driving;
recording images with a camera comprising at least one camera;
determining a vehicle moving direction in response to the signal of the turn signal switch;
recognizing a lane from the image in correspondence to the vehicle moving direction;
calculating an included angle between the lane and the driving direction; and
adjusting positions of the side-view mirrors with respect to any one of the side-view mirrors including a first mirror and a second mirror.

13. The method of controlling a side-view mirror control apparatus according to claim 12, wherein recognizing the lane comprises determining that the vehicle will move to a left side when a signal is received from a left switch of the turn signal switch, recognizing a left lane of the driving lane from the image, determining that the vehicle will move to a right side when a signal is received from the right switch, and recognizing a right lane of the driving lane from the image.

14. The method of controlling a side-view mirror control apparatus according to claim 12, wherein calculating the included angle further comprises:
calculating an equation of the lane connecting points or lines extracted from the recognized lanes; and
calculating the included angle based on the equation of the lane.

15. The method of controlling a side-view mirror control apparatus according to claim 12, further comprising, before adjusting the positions of the side-view mirrors:
sensing a speed of the vehicle; and
setting a speed for changing the positions of the side-view mirrors in correspondence with the speed of the vehicle.

16. The method of controlling a side-view mirror control apparatus according to claim 15, wherein setting the speed includes:
dividing driving into low speed driving, common driving, and high speed driving according to the speed of the vehicle;
adjusting the positions of the side-view mirrors at a first speed during common driving, adjusting the positions of the side-view mirrors at a second speed, faster than the first speed, during low speed driving, and adjusting the positions of the side-view mirrors at a third speed, slower than the first speed, during high speed driving.

17. The method of controlling a side-view mirror control apparatus according to claim 12, further comprising, before adjusting the positions of the side-view mirrors:
recognizing a road sign from the image;
outputting an announcement to conduct low speed driving in a speed limit zone according to the road sign; and
setting the positions of the side-view mirrors to be rapidly changed during low speed driving.

18. The method of controlling a side-view mirror control apparatus according to claim 12, wherein adjusting the positions of the side-view mirrors further comprises:
calculating rotation angles of the side-view mirrors that correspond to the included angles; and
driving motors connected to the side-view mirrors to adjust the positions of the side-view mirrors to a direction of at least one of up, down, left, and right.

19. The method of controlling a side-view mirror control apparatus according to claim 12, further comprising:
determining that the movement to the lane is completed when the lane and the driving direction coincide with each other and when the turn signal switch is switched off; and
returning the positions of the side-view mirrors when the movement to the lane is completed.

20. The method of controlling a side-view mirror control apparatus according to claim 19, wherein the returning of the positions of the side-view mirrors comprises:
returning the positions of the side-view mirrors to preset reference positions; and
returning the positions of the side-view mirrors to positions before moving to the lane when the reference position is not set.
